(19) United States
(12) Patent Application Publication
(10) Pub. No.: US 2008/0204929 A1
(43) Pub. Date: Aug. 28, 2008

(54) FLUID DYNAMIC BEARING DEVICE, SPINDLE MOTOR INCLUDING THE SAME, READ-WRITE DEVICE, AND METHOD OF MANUFACTURING BEARING PART

(76) Inventors: Shoji Masazuki, Ehime (JP); Toshifumi Hino, Ehime (JP); Kenichi Yano, Ehime (JP); Nobuhiko Sato, Ehime (JP)

Correspondence Address: WENDEROTH, LIND & PONACK L.L.P., 2033 K. STREET, NW, SUITE 800, WASHINGTON, DC, 20006, US

(21) Appl. No.: 12/031,099

(22) Filed: Feb. 14, 2008

(30) Foreign Application Priority Data
Feb. 16, 2007 (JP) 2007-037000

(51) Int. Cl. G11B 5/33; F16C 32/06; H02K 7/08

(52) U.S. Cl. 360/110; 384/110; 310/90

(57) ABSTRACT

An object of the present invention is to provide a method of manufacturing a fluid dynamic bearing device and a bearing part for a thrust bearing, both of which are applied to a flat and thin bearing part and are capable of preventing abrasion and scratching even if two parts make contact with each other. A fluid dynamic bearing mechanism 40 includes a shaft 1 functioning as an axis of rotational, a sleeve, a flange 3, a thrust plate 4, and a thrust bearing portion 22. The sleeve is disposed on the outer peripheral side of the shaft. The flange is disposed in the vicinity of the end portion of the shaft, and includes a bottom surface 3c perpendicular to a central axis direction of the shaft. A thrust receiver includes a front surface 4a opposed to the bottom surface. The thrust bearing portion is formed between the bottom surface and the front surface, and includes a plurality of thrust dynamic generation grooves 3a formed on the bottom surface. Particulates with hardness higher than that of the top surface are diffused and disposed on the bottom surface, and are then implanted in the bottom surface by applying pressure such that a portion of the particulates extends therefrom.

### BACKGROUND OF THE INVENTION

1. Field of the Invention

The present invention relates to a fluid dynamic bearing device including a fluid bearing portion, a spindle motor using the same, a read-write device, and a method of manufacturing a part for a bearing.

2. Description of the Related Art

A fluid dynamic bearing device in which a rotational side is rotated in a non-contact state has been conventionally used as a spindle motor configured to be used for a read-write device such as a magnetic disk drive and a flexible disk drive (see e.g., Japanese Patent Application Publication Nos. JP-A-2006-144864 (published on Jun. 8, 2006) and JP-A-2002-188638 (published on Jul. 5, 2002)). In the conventional fluid dynamic bearing device, a thrust dynamic pressure generation portion is formed on one of the surface of a sleeve and the surface of a flange of a shaft. In addition, a sleeve configured to be a rotational side or a shaft is rotated, and the dynamic pressure is generated in the thrust dynamic pressure generation portion. Accordingly, the rotational side is rotated in a non-contact state produced by generating a predetermined gap between the both members.

In this type of fluid dynamic bearing device, a variety of countermeasures are performed for preventing seizure and abrasion of a shaft including a flange. The Japanese Patent Application Publication No. JP-A-2006-144864 discloses a fluid dynamic bearing device in which iron metal having austenite structure is used for a shaft in order to enhance cleaning rate and a surface processing layer is provided by injecting powder of solid lubricant on the surface of the shaft. Anti-abrasion property is enhanced by the surface processing layer on which the above described solid lubricant is diffused, and accordingly higher reliability is achieved for a bearing.

The Japanese Patent Application Publication No. JP-A-2002-188638 discloses a fluid dynamic bearing device in which stainless steel is used as a base material of one of a sleeve and a shaft, and copper material is used as a base material for the other. A nitride processing is performed for the member including stainless steel in order to enhance anti-abrasion property of the surface. Also, the Japanese Patent Application Publication No. JP-A-2002-188638 discloses that material including Si of 1-2% as a copper material and further including metal elements of Mn, Al, Fe, and Ni, respectively. In addition, a diamond-like-carbon (DLC) film is formed on the surface of the shaft.

However, the above described conventional fluid dynamic bearing devices have the following problems.

In the fluid dynamic bearing device disclosed in the Japanese Patent Application Publication No. JP-A-2006-144864, the solid lubricant is self-abraded. Therefore, there is a possibility that the sleeve and the flange make contact with each other in the start-up and the shutdown and thus abrasion is advanced. In addition, the solid lubricant has low-hardness and is soft. Therefore, when a surface processing layer is formed with the solid lubricant, if a convex portion is formed on the opposed portion to the surface processing layer, the surface processing layer may be scratched and damaged by the load applied in the start-up and the shutdown.

In the fluid dynamic bearing device disclosed in the Japanese Patent Application Publication No. JP-A-2002-188638, soft copper material is used and Si is included in the copper material. Therefore, when the start-up operation and the shutdown operation are repeatedly preformed, load is applied to the sleeve or the flange for which the copper material is used, and thus the sleeve or flange is easily deformed. Also, it is required to produce sintered alloy from material with a mold, and thus it is not suitable for a flat and thin shape adopted by members such as a flange.

An object of the present invention is to provide a fluid dynamic bearing device that is configured to be applied to a flat and thin shaped bearing part and is configured to prevent abrasion and scratch from being generated even when two parts make contact with each other, and a method of manufacturing a bearing part for a thrust bearing.

### SUMMARY OF THE INVENTION

A fluid dynamic bearing device in accordance with a first invention includes a shaft member that serves as a rotational center, a sleeve member, a first surface, a second surface, a dynamic pressure bearing portion, and a plurality of particulates. The sleeve member is disposed on the outer peripheral side of the shaft member, and a minute gap is formed between the sleeve member and the shaft member. The sleeve member is relatively rotatably supported. The first surface, which is opposed to the inner surface of a bearing hole of the sleeve member, is formed in the shaft member. The second surface is formed on the sleeve member through a minute gap with respect to the first surface. The dynamic pressure bearing portion includes a plurality of dynamic pressure generation grooves and a lubricating fluid being held in the minute gap. The plurality of dynamic pressure generation grooves formed on at least one of the first surface and the second surface. The plurality of particulates are diffused and disposed on a portion or the entire of one of the first surface and the second surface, and are implanted thereinto by applying pressure such that a portion of the particulates protrudes therefrom. Note that the sleeve member in this statement includes other members (for example, thrust plate) which comprise bearing and fixed on to sleeve. And the meaning of bearing hole includes whole sleeve internal surface. It includes radial bearing portion and thrust bearing portion. So if the bearing member has a flange, the bearing includes the concave in which the flange is inserted. Here, the particulates have hardness higher than that of the other surface opposed to the surface that the particulates are implanted therein. The particulates are implanted into the other surface by applying pressure such that a portion of the particulates protrudes from the other surface. In addition, dynamic pressure generation grooves are formed on either the surface into which the particulates are implanted or the surface into which no particulate is implanted.

Here, the first surface and the second surface, both of which form a dynamic pressure bearing portion, may contact with each other in the low-speed rotation performed such as in the start-up and the shutdown. Here, a portion of the particulates protrudes from the surface. Therefore, an uneven (concave-convex) surface is generated by the particles, and thus a gap is generated between the first surface (e.g., a flange shaped member fixed to the shaft) and the second surface (e.g., a thrust receiver formed on the sleeve portion). As a result, an absorption phenomenon is not easily generated between the first surface and the second surface in the low-speed rotation. In addition, lubricant oil enters into the gap, and thus it prevents abrasion from easily advancing. Furthermore, the uneven surface is formed. Accordingly, the area that the first surface and the second surface make contact with each other will be reduced, and the load torque by the frictional resistance will be reduced. As a result, the rotation speed will be rapidly increased to the floating rotational speed. Thus, it prevents abrasion of the other surface from easily advancing. In addition, the hard particulates whose hardness is higher than that of the other surface make contact with the other surface. Therefore, abrasion and seizure with respect to the other surface are prevented from being easily generated. Also, the particulates are diffused and disposed. Therefore, it is possible to prevent the surface pressure from being increased. Based on the above described factors, it is possible to prevent abrasion and/or scratch of the both surfaces from being generated.

The area of the diffused and disposed particulates is preferably in the range of 3-10% of the area that the first surface and the second surface are opposed to each other. When the area of the particulates is less than 3% of the opposed area of the first and second surfaces, the surface pressure applied to one of the particulates will be increased. Accordingly, there is a possibility that the particulates scratch the other surface. On the other hand, when the area of the particulates is more than 10% of the opposed area of the first and second surfaces, duration when the particulates are attached to the other surface will be longer. Accordingly, manufacturing cost will be increased.

In addition, the Vickers hardness (Hv) of the particulates is preferably more than 800, and that of the other surface into which no particulate is implanted is preferably greater than 400 to 600. When the hardness of the particulates is less than 800 and/or that of the other surface is more than 600, difference between the hardness of the particulates and that of the other surface will be smaller, and thus seizure may be generated between the one surface and the other surface. The particulates herein described are produced by breaking up bulk-shaped chunk, and the Vickers hardness is a value obtained by measuring the bulk-shaped chunk before the chunk is broken up. The value is normally used because the hardness is maintained even after the chunk is broken up.

Note that the shaft member may be fixed or rotated as long as the shaft member and the sleeve member are configured to relatively rotate. In addition, the dynamic pressure generation grooves are formed in a shape such as a spiral shape or a herringbone shape, the center of which is the central axis of the shaft member.

A fluid dynamic bearing device in accordance with a second invention is the fluid dynamic bearing device according to the first invention. Here, the particulates are implanted into a surface on which the dynamic pressure generation grooves are formed, and the surface on which the dynamic pressure generation grooves are formed has hardness lower than that of the other surface on which no dynamic pressure generation groove is formed. Here, the particulates are implanted into the surface on which the dynamic pressure generation grooves are formed, and the surface on which the dynamic pressure generation grooves are formed has hardness lower than that of the other surface on which no dynamic pressure generation groove is formed.

Here, in such a case that a thrust dynamic pressure groove is formed on a surface, the thrust dynamic pressure generation groove is normally formed by press working called coining (or repressing). Therefore, when the hardness is high, it is difficult to form a high-precision thrust dynamic pressure generation groove. Therefore, the hardness of the surface on which the thrust dynamic pressure generation groove is formed is configured to be lower than that of the surface opposed to the surface on which the thrust dynamic pressure generation groove is formed. When the particulates are implanted into the low-hardness surface by applying pressure, the implantation is more easily performed compared to the implantation of the particulates into a high-hardness surface. In addition, it is also possible to simultaneously implant the particulates in the press process for forming the thrust dynamic pressure generation groove. In this case, it is possible to simplify the manufacturing process, and it is also possible to prevent the manufacturing cost from increasing. Note that the Vickers hardness of the surface into which the particulates are implanted is preferably 350 or less.

In addition, the surface on which the thrust dynamic pressure generation groove is formed and the surface on which no thrust dynamic pressure generation groove is formed may make contact with each other in the start-up and the shutdown. However, when the particulates are implanted into the surface on which the thrust dynamic pressure generation groove is formed, a gap is generated between the two surfaces. Thus, the surface on which the thrust dynamic pressure generation groove is formed is prevented from being easily scraped by the hard other surface. Because of this, deformation, such as deformation in the depth of the thrust dynamic pressure generation groove, is not easily generated by abrasion, and thus it is possible to generate stable dynamic pressure in the thrust dynamic pressure generation groove.

Note that the dynamic pressure generation groove is not limited to a groove configured to form a thrust bearing portion. For example, the dynamic pressure generation groove may be formed on the outer peripheral surface of the cylindrical portion of the shaft member configured to form a radial bearing portion, or on a bearing part forming a conical bearing portion including portions that slant with respect to the central axis of the shaft portion and are opposed to each other.

A fluid dynamic bearing device in accordance with a third invention is the fluid dynamic bearing device according to the first invention, and the first surface and the second surface form a thrust bearing portion and a radial bearing portion. The thrust bearing portion includes portions that are configured to be opposed to each other in an axial direction of the shaft member, and the radial bearing portion includes portions that are configured to be opposed to each other in a radial direction of the shaft member. With this configuration, it becomes possible to process a bearing part by a lathe with the processing accuracy of approximately sub-μm. Accordingly, it is possible to prevent manufacturing cost from remarkably increasing.

A fluid dynamic bearing device in accordance with a fourth invention is the fluid dynamic bearing device according to the third invention, and the shaft member includes on a flange-shaped portion fixed in the vicinity of the end portion of the shaft member. As a result, it is possible to apply the present invention to the flat and thin shaped flange-shaped portion, and it is possible to prevent the flange-shaped portion from being abraded and scratched. Especially, it is possible to contribute to production of the thinner motor by applying the present invention to the shaft-rotation type fluid dynamic bearing device.

In addition, with this configuration, it is possible to increase the dynamic pressure generated in the thrust bearing portion, to float the thrust bearing portion in a short time during the start-up, and to prevent the thrust bearing portion from being abraded. It is also possible to enhance the bearing stiffness in the thrust bearing and to enhance rotational accuracy of the bearing. Note that the flange (the flange-shaped member) attached to the shaft may be integrally formed with the shaft or may be fixed to the shaft by means of laser welding, adhesion, or the like. Note that the second surface (the thrust bearing portion) opposed to the first surface may be a part of the sleeve or a part of a member such as an annular member and a plate-shaped member attached to the sleeve.

A fluid dynamic bearing device in accordance with a fifth invention is the fluid dynamic bearing device according to the third invention, and the first surface is formed on the end surface of the shaft member. With this configuration, it becomes possible to further contribute to production of a thinner motor.

A fluid dynamic bearing device in accordance with a sixth invention is the fluid dynamic bearing device according to the third invention, and the sleeve member is formed by a sleeve and a thrust plate. Here, the sleeve serves as a main body, and the thrust plate is relatively fixed to the sleeve.

A fluid dynamic bearing device in accordance with a seventh invention is the fluid dynamic bearing device according to the first invention, and the first surface and the second surface form a conical bearing portion including portions that are configured to be opposed to each other and slant toward the central axis of the shaft member.

A fluid dynamic bearing device in accordance with an eighth invention is the fluid dynamic bearing device according to the first invention, and the particulates include at least one of the group of oxide aluminum particle, silicon particle, silicon carbide particle, chrome oxide particle, diamond particle, silicon nitride particle, cerium oxide particle, and titanium carbide particle. Here, the particulates are composition of abrasive to be used in a normal barrel finishing process and the like. Therefore, it is possible to use the abrasive used in the barrel finishing as the particulates. Accordingly, there is no need to prepare particulates to be used exclusively for implantation. Thus, the manufacturing process is further simplified and it is possible to further prevent the manufacturing cost from increasing.

Here, the sizes of the particulates are preferably 1-10 μm. When the size of the particulates is less than 1 μm, remarkable change is not caused for the roughness of the surface in a bearing part because its roughness is normally configured to be approximately 0.35 μm. Accordingly, the above described effect by the uneven surface is not achieved. On the other hand, when the size of the particulates is more than 10 μm, it will be difficult for the particulates to attach to one of the surfaces.

A spindle motor in accordance with a ninth invention includes the fluid dynamic bearing device according to the first invention.

A read-write device in accordance with a tenth invention includes the spindle motor according to the sixth invention.

A method of manufacturing a bearing part in accordance with an eleventh invention is a method of manufacturing a bearing part for a thrust bearing of a fluid bearing device, and includes a disposing step for diffusing and disposing hard particulates on a surface of a plate portion that is made of metal and serves as the bearing part, and an implantation step for implanting the disposed particulates into the surface by applying pressure such that a portion of the particulates protrude from the surface. In addition, the particulates have hardness higher than that of the plate shape portion.

Here, the bearing part is manufactured by diffusing and disposing particulates with high-hardness on the plate shaped portion that is made of metal such as a stainless steel, and by implanting the disposed particulates by applying pressure such that a portion of the particulates protrudes from the surface. When the particulates are thus implanted into the surface, an uneven surface with rough-roughness is formed by the particulates that protrude from the surface. When a thrust bearing for a fluid dynamic bearing device is formed by one bearing part with the above described uneven surface and the other bearing part that is disposed to be opposed to the one bearing part and has hardness lower than that of the particulates, a gap is generated between the both parts by the uneven surface. As a result, an absorption phenomenon is not easily generated in the both parts. In addition, lubricant oil enters into the gap between the both parts, and thus it prevents abrasion from easily advancing. Furthermore, the uneven surface is formed. Accordingly, the contact area between the both parts will be reduced, and the load torque by the frictional resistance will be reduced. As a result, the rotation speed will be rapidly increased to the floating rotational speed. Accordingly, it prevents abrasion from easily advancing. In addition, the particulates whose hardness is harder than that of the other part make contact with the other part. Therefore, abrasion and seizure are prevented from being easily generated. Furthermore, the particulates are diffused and disposed, and thus it is possible to prevent the surface pressure from being increased. Based on the above described factors, it is possible to prevent abrasion and scratch of the other surface from being generated.

A method of manufacturing a bearing part in accordance with a twelfth invention is the method of manufacturing a bearing part according to the eleventh invention, and the disposing step includes a barrel finishing step for grinding the surface, and the particulates are abrasive that are broken up and attached in the barrel finishing process.

Here, the abrasive that are broken up and attached in the barrel finishing process is implanted as particulates in the implanting step. Here, it is possible to dispose the particulates in a process of barrel finishing for the surface of the bearing part. Therefore, it is possible to simplify the manufacturing process. Accordingly, it is possible to reduce the manufacturing cost of the bearing part. Note that the vibration barrel and the centrifugal barrel are included in the barrel finishing, and the vibration barrel has a higher effect to cause attachment of the particulates compared to the centrifugal barrel.

A method of manufacturing a bearing part in accordance with a thirteenth invention is the method of manufacturing a bearing part according to the twelfth invention, and the abrasive is formed by combining particles with a binder, and the particulates are residuals as a result of breaking up the binder. Note that the particles include at least one of the large particle group of aluminum oxide particle, silicon particle, silicon carbide particle, chrome oxide particle, diamond particle, silicon nitride particle, cerium oxide particle, and titanium carbide particle. Also, note that the abrasive includes at least one of the small particle group of aluminum oxide particle, silicon particle, silicon carbide particle, chrome oxide particle, diamond particle, silicon nitride particle, cerium oxide particle, and titanium carbide particle.

Here, the binder includes at least one of the small particles (e.g., particles with the size of 1-10 μm) of aluminum oxide particle, silicon particle, silicon carbide particle, chrome oxide particle, diamond particle, silicon nitride particle, cerium oxide particle, and titanium carbide particle, and further includes soft binding material that is used for binding them and is combined by means of calcination with such material as clayey binding material. In addition, the binder binds large particles (e.g., particles with the size of 40-250 μm) to each other, which include at least one of aluminum oxide particle, silicon particle, silicon carbide particle, chrome oxide particle, diamond particle, silicon nitride particle, cerium oxide particle, and titanium carbide particle. Therefore, when a grinding is performed with an abrasive including large particulates for grinding a surface, the hard large particles are not deformed, but the soft binding material is broken up and the small particles included in the binder will attach to the surface. The attached residual small particles are used as particulates for implantation. Therefore, it is easy to implant the particulates.

A method of manufacturing a bearing part in accordance with a fourteenth invention is the method of manufacturing a bearing part according to the eleventh inventions, and the implantation step includes a groove formation step for forming a thrust dynamic pressure groove on the surface by applying pressure, and the particulates are simultaneously implanted into the surface in forming the thrust dynamic pressure generation groove.

Here, the particulates disposed on the surface of the plate-shaped portion are implanted into the surface in a step of forming the thrust generation groove. Therefore, it is possible to perform formation of the thrust generation groove and implantation of the particulates in a single step. Thus, it is possible to further simplify the manufacturing step. Accordingly, it is possible to reduce the manufacturing cost of the bearing part.

According to the fluid dynamic bearing device, a portion of the particulates protrude from a surface. Accordingly, an uneven (concave-convex) surface is formed by the particulates, and a gap is generated between the shaft member and the sleeve member. As a result, an absorption phenomenon is not easily occurred between the first surface and the second surface in the low-speed rotation. In addition, lubricant oil enters into the gap, and thus it prevents abrasion from easily advancing. Furthermore, the uneven surface is formed. Accordingly, the area that the first surface and the second surface make contact with each other will be reduced, and the load torque by the frictional resistance will be reduced. As a result, the rotation speed will be rapidly increased to the floating rotational speed. Thus, it prevents abrasion of the other surface from easily advancing. In addition, the hard particulates whose hardness is higher than that of the other surface make contact with the other surface. Therefore, abrasion and seizure with respect to the other surface are prevented from being easily generated. Also, the particulates are diffused and disposed. Therefore, it is possible to prevent the surface pressure from being increased. Based on the above described factors, it is possible to prevent abrasion and scratch of the other surface from being generated.

According to the method of manufacturing the bearing part in accordance with the present invention, when a bearing part is manufactured by implanting particulates into a surface such that a portion of the particulates protrude from the surface, an uneven surface with high-roughness is formed by the particulates protruding from the surface. When a dynamic pressure bearing for a fluid dynamic bearing device is configured by a pair of bearings, that is, one bearing part with the above described uneven surface and the other bearing part that is disposed to be opposed to the one bearing part and has hardness lower than that of the particulates, a gap is generated between the both parts by the uneven surface. As a result, an absorption phenomenon is not easily generated in the both parts. In addition, lubricant oil enters into the gap between the both parts, and thus it prevents abrasion from easily advancing. Furthermore, the uneven surface is formed. Accordingly, the contact area between the both parts will be reduced, and the load torque by the frictional resistance will be reduced. As a result, the rotation speed will be rapidly increased to the floating rotational speed. Accordingly, it prevents abrasion from easily advancing. In addition, the particulates whose hardness is harder than that of the other part make contact with the other part. Therefore, abrasion and seizure are prevented from being easily generated. Furthermore, the particulates are diffused and disposed, and thus it is possible to prevent the surface pressure from being increased. Based on the above described factors, it is possible to prevent abrasion and scratch of the other surface from being generated.

### BRIEF DESCRIPTION OF THE DRAWINGS

Referring now to the attached drawings which form a part of this original disclosure:

FIG. 1 is a cross-sectional view of a configuration of a spindle motor in which a fluid dynamic bearing device in accordance with an embodiment of the present invention is mounted;

FIG. 2 is an overall vertical cross-sectional view of a fluid dynamic bearing mechanism 40 included in the fluid bearing device in FIG. 1 and the vicinity thereof;

FIG. 3 is an overall cross-sectional view of a simplified configuration of a thrust bearing portion of the fluid dynamic bearing mechanism in FIG. 2;

FIG. 4 is a flowchart illustrating a manufacturing method of a flange;

FIG. 5 is a front view of an abrasive;

FIG. 6 is a cross-sectional frame format of an abrasive;

FIG. 7 is a frame format illustrating an implantation process that starts from attachment of particulates;

FIG. 8 is a perspective view of a flange in which a thrust dynamic pressure generation groove is illustrated;

FIG. 9 is a chart including a line graph illustrating relations between the flange wear amount and the number of tests in both the present invention and a comparative example;

FIG. 10 is a cross-sectional view of an internal configuration of a spindle motor in accordance with the other embodiment of the present invention;

FIG. 11 is a cross-sectional view of an internal configuration of a spindle motor in accordance with the other embodiment of the present invention;

FIG. 12 is a cross-sectional view of an internal configuration of a spindle motor in accordance with the other embodiment of the present invention; and

FIG. 13 is a cross-sectional view of an internal configuration of a read/write device in accordance with the other embodiment of the present invention.

### DETAILED DESCRIPTION OF THE INVENTION

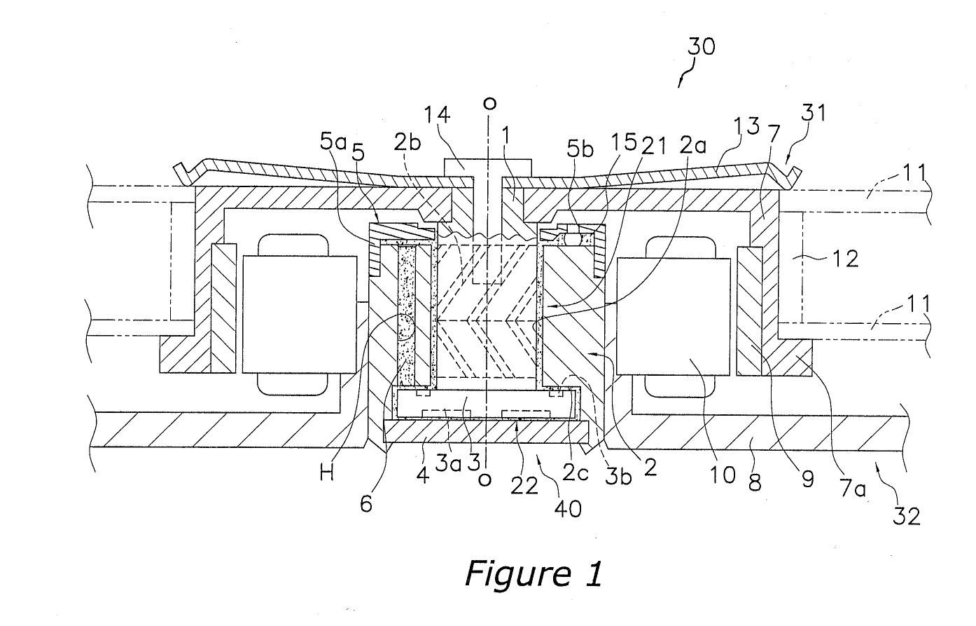

A spindle motor in which a fluid dynamic bearing device in accordance with an embodiment of the present invention is mounted will be hereinafter explained with reference to FIGS. 1 to 6.

Note that in FIG. 1, upward and downward directions, an upward direction, and a downward direction are respectively expressed as “axial direction,” “upper side of the axial direction” (one side of the axial direction), and “lower side of the axial direction” (the other side of the axial direction). However, an actual attachment condition of the fluid dynamic bearing mechanism 40 (an example of a fluid dynamic bearing device) is not limited by these expressions.

### Entire Configuration of Spindle Motor 30

As illustrated in FIG. 1, a spindle motor 30 in accordance with the present embodiment is a device for rotationally-driving a recording disk (recording medium) 11, and mainly includes a rotation member 31, a stationary member 32, and the fluid dynamic bearing mechanism 40.

The rotation member 31 mainly includes a hub 7 to which the recording disk 11 is mounted, and a rotor magnet 9.

The hub 7 is integrated with a shaft 1 that is disposed in the center of the hub 7 by means of press-fitting bonding or by integrally forming the both members. In addition, the hub 7 is provided with a disk mounting portion 7a for mounting two recording disks 11 on the outer peripheral portion thereof on the lower side of the axial direction.

The rotor magnet 9 is fixed on the surface of the inner peripheral side of the hub 7, and forms a magnet circuit with a stator 10 to be described.

The two recording disks 11 are disposed on the outer peripheral side of the hub 7 and are engaged with the hub 7 through an annular spacer 12. In addition, the recording disks 11 are mounted on the disk mounting portion 7a. Furthermore, the recording disks 11 are pressed toward the lower side of the axial direction by a clamper 13 that is fixed to the shaft 1 on the upper side of the axial direction by a screw 14, and are thus interposed between the clamper 13 and the disk mounting portion 7a.

As illustrated in FIG. 1, the stationary member 32 mainly includes a base 8 and the stator 10 fixed to the base 8.

The base 8 forms a base portion of the spindle motor 30.

The stator 10 is disposed on the outer peripheral side of an opening that is formed in approximately the center of the base 8 for disposing the spindle motor 30 to be described. In addition, the stator 10 is disposed in a position opposing to a rotor magnet 9 mounted to the inner peripheral surface of the hub 7.

### Configuration of Fluid Dynamic Bearing Mechanism 40

The fluid dynamic bearing mechanism 40 is fixed in the opening formed in approximately the center of the base 8, and supports the rotation member 31 while the rotation member 31 is allowed to rotate with respect to the stationary member 32.

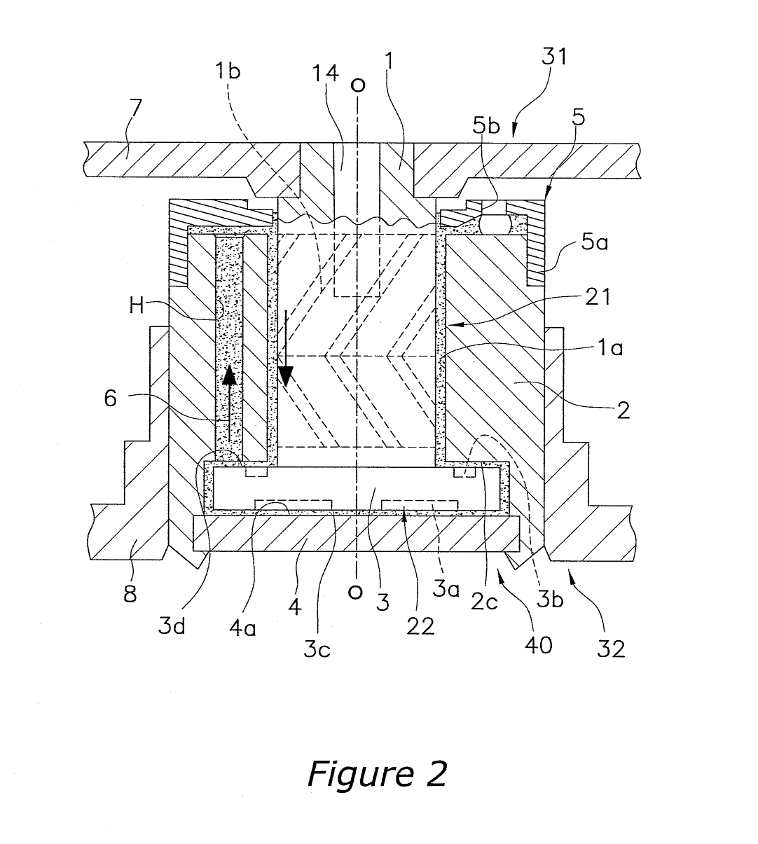

As illustrated in FIG. 2, the fluid dynamic bearing mechanism 40 mainly includes the shaft 1 (main body of a shaft member) functioning as a center of rotation, a sleeve 2 as a main body of a sleeve member, a flange 3 (an example of an added part of a shaft member), a thrust plate 4 (an example of a thrust receiver as an added part of the sleeve member), and a thrust bearing portion 22. Note that amongst the members, the sleeve 2 and the thrust plate 4 are configured to be stationary members, and the shaft 1 and the flange 3 are configured to be rotational members.

### Configuration of Shaft 1

The shaft 1 is a cylindrical member formed to extend in a direction of a rotational center axis O-O, and supports the hub 7 while the hub 7 is allowed to rotate with respect to the stationary member 32. Specifically, the shaft 1 is supported to be allowed to rotate with respect to the inner peripheral side of a bearing hole 2a formed by the sleeve 2 and the thrust plate 4 through a gap. In addition, the hub 7 is fixed on the end portion of the shaft 1 on the upper side of the axial direction.

Furthermore, the shaft 1 includes a plurality of radial dynamic pressure generation grooves 1b on the outer peripheral surface thereof. Therefore, a radial bearing portion 21 including the radial dynamic pressure generation grooves 1b is formed between the sleeve 2 and the shaft 1. For example, the radial dynamic pressure generation grooves 1b are formed in a herringbone shape, the upper and lower shapes of which are non-symmetrically formed in the axial direction. In addition, the shaft 1 including the rotation member 31 is supported in a direction approximately vertical to the axial direction by means of the support pressure to be generated in the radial bearing portion 21.

Note that the shaft 1 is made of stainless steel and the like, for instance. Here, the radial dynamic pressure generation grooves 1b, which are formed on the outer peripheral surface of the shaft 1, may be formed on the inner peripheral surface of the sleeve 2.

### Configuration of Sleeve 2

The sleeve 2 is an approximately cylindrical shaped member that is made of, for example, pure iron, stainless steel, copper alloy, and sintered metal, and is formed to extend in the axial direction. In addition, the sleeve 2 is fixed to the base 8 with adhesive or the like. In addition, an approximately circular shaped opening is formed on the end portion of the sleeve 2 on the lower side of the axial direction, and the thrust 4 is fixed to the sleeve 2 for blocking the opening. Here, the bearing hole 2a is formed by the sleeve 2 and the thrust plate 4.

In addition, the sleeve 2 includes an annular recess 2c on the end portion thereof on the lower side of the axial direction, and the outer peripheral portion of the flange 3 is accommodated in a space between the recess 2c and the thrust plate 4.

Furthermore, a circulation hole H is formed in the sleeve 2. Specifically, as illustrated in FIGS. 1 and 2, the circulation hole H is a through hole formed to extend along the axial direction, and thus the top surface and the bottom surface of the sleeve 2 are communicated with each other. In addition, the circulation hole H is formed to be communicated with a position opposing to a thrust sub bearing portion including an after-mentioned thrust dynamic pressure generation grooves 3b formed in the flange 3. With the above described configuration, the spindle motor 30 is prevented from having a large dimension in a radial direction. Thus, it is possible to meet the demand of the small and thin typed spindle motor.

Note that a plurality of circulation holes H may be formed in the circumferential direction.

### Configuration of Flange 3

The flange 3 is a disk-shaped member made of nonmagnetic austenitic stainless steel with relatively low hardness such as SUS304 (JIS). Specifically, the Vickers hardness of the flange 3 is approximately 200-320. In the present embodiment, SUS304 material with the Vickers hardness 200 is processed and hardened by the press molding, and thus the Vickers hardness is enhanced to 320. The flange 3 is fixed to the end portion of the shaft 1 on the lower side of the axial direction so to be opposed to the thrust plate 4. Note that the flange 3 may be fixed to the shaft 1 as a separate member, and also may be integrally formed with the shaft 1. The flange 3 includes a bottom surface 3c (an example of a first surface) and a top surface 3d, both of which are disposed to be perpendicular to the direction of the rotational center axis O-O. Both of the surfaces 3c and 3d are processed by the rough grinding so as to have the average surface roughness (Ra) of 0.32 μm or less. The bottom surface 3c is disposed to be opposed to the front surface 4a (an example of a second surface) of the thrust plate 4. The top surface 3d is disposed to be opposed to the recess 2c of the sleeve 2. A plurality of thrust dynamic pressure generation grooves 3a and 3b are respectively formed on the bottom surface 3c and the top surface 3d. Therefore, the thrust bearing portion 22, which includes the thrust dynamic pressure generation grooves 3a and 3b, are formed among the flange 3, the sleeve 2, and the thrust plate 4.

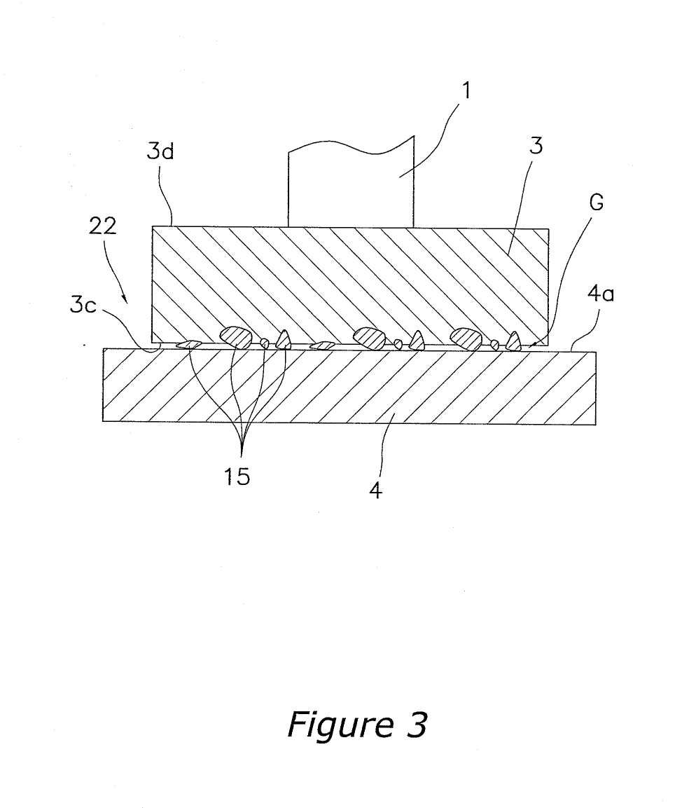

In addition, as illustrated in a simplified diagram of FIG. 3, a plurality of particulates 15 are diffused and disposed on the bottom surface 3c on which the thrust dynamic pressure generation grooves 3a reformed. The particulates 15 are implanted in the bottom surface 3c such that a portion of the particulates 15 protrudes from the bottom surface 3c by applying pressure, for instance, by means of the press working. For example, the particulates 15 include at least one of the group of silicon particle, aluminum oxide particle, and the like. The particulates 15 are preferably those with Vickers hardness 800 or greater. The Vickers hardness of the above described silicon and that of the above described aluminum oxide are approximately 1000 and approximately 2200, respectively. Accordingly, these values meet the above described condition. When the Vickers hardness of the particulates 15 is less than 800, difference between the hardness of the particulates 15 and that of the thrust plate that is a corresponding object to the particulates 15 will be reduced. Therefore, abrasion and/or seizure is/are easily generated between the particulates 15 and the thrust plate 4, and thus the thrust plate will be easily scratched.

In the low-speed rotation, which is performed in such a condition as the start-up and the shutdown, the flange 3 and the thrust plate 4 may contact with each other because of insufficient dynamic pressure force of the thrust bearing portion 22. When the particulates 15 with high-hardness are diffused and implanted in the bottom surface 3c of the flange such that a portion of the particulates 15 protrudes from the bottom surface 3c in this low-speed rotation, an uneven (concave-convex) surface is formed by the particulates 15 because a portion of the particulates 15 protrudes from the bottom surface 3c. Thus, as illustrated in FIG. 3, a gap G is generated between the flange 3 and the thrust plate 4. As a result, an absorption phenomenon is not easily generated between the bottom surface 3c of the flange 3 and the front surface 4a of the thrust plate 4. In addition, oil 6, which functions as a lubricating fluid, enters into the gap G, and thus it prevents abrasion from easily advancing. Furthermore, the uneven surface is formed. Accordingly, the contact area between the bottom surface 3c and the front surface 4a will be reduced, and the load torque by the frictional resistance will be reduced. As a result, the rotation speed will be rapidly increased to the floating rotational speed. Thus, it prevents abrasion of the other surface from easily advancing. In addition, the hardness of the particulates 15 is higher than that of the front surface 4a of the thrust plate 4, and the hard particulates 15 make contact with the front surface 4a. Therefore, abrasion and seizure are prevented from being easily generated between the bottom surface 3c and the front surface 4a. Furthermore, the particulates 15 are diffused and disposed, and therefore it is possible to prevent surface pressure from being increased. Based on the above described factors, it is possible to prevent abrasion and/or scratch of the both surfaces from being generated.

As illustrated in FIG. 8, the thrust dynamic pressure generation grooves 3a is formed in a herringbone shape, for instance. Also the thrust dynamic pressure generation grooves 3b (no shown in FIG. 8) which is on the reverse side of flange 3 is formed in a herringbone shape. However, the shape of the thrust dynamic pressure generation grooves 3a and 3b are not limited to the herringbone shape. They may be formed in a spiral shape or the other shapes.

The shaft 1 and the rotation member 31 are supported in the axial direction by the support pressure to be generated in the thrust bearing portion 22.

Manufacturing method of Flange 3

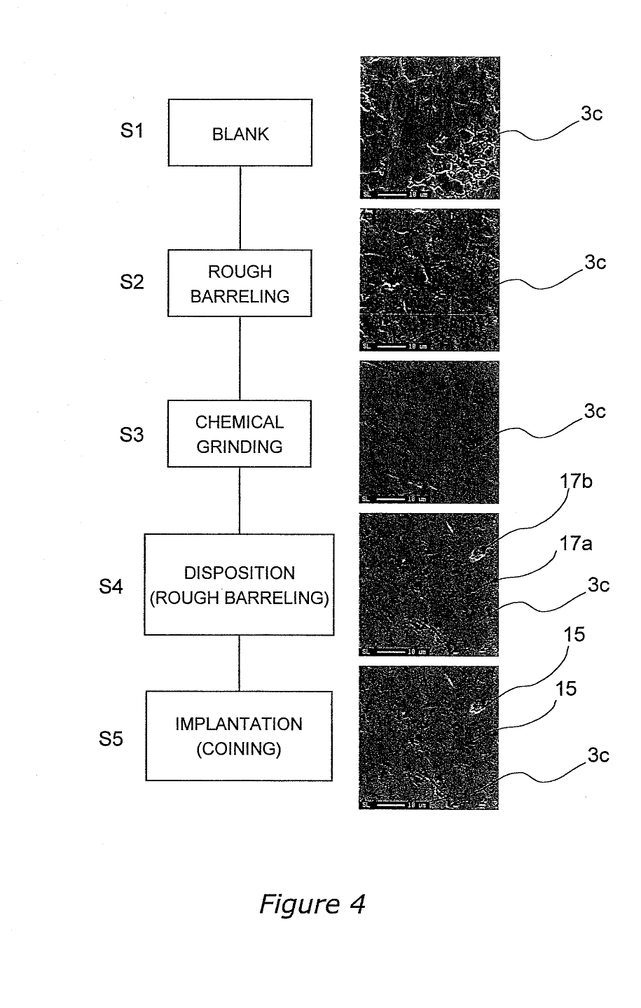

The flange 3 as the above described bearing part is manufactured in a manufacturing process illustrated in FIG. 4. Note that in FIG. 4, states of a surface to be processed (i.e., the bottom surface 3c) in each step of the process are illustrated with photographs, and they are located to correspond to each step of the process.

In a first step S1 (i.e., a blank step), a SUS304 blank, which is used as material of the flange 3, is prepared. As described above, the Vickers hardness of the surface of the blank is preliminarily enhanced to 320 by the press working.

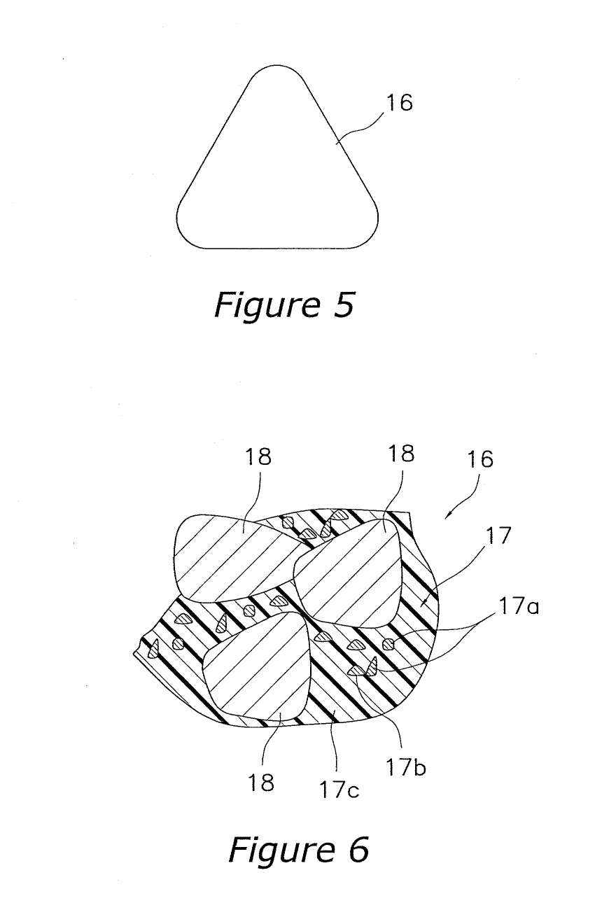

Next, in a step S2, a rough barrel finishing process is performed for the surface by a vibration barrel finishing machine for about three hours, for instance. As illustrated in FIG. 5, an abrasive 16 (i.e., barrel media) to be used here is an approximately triangle-shaped material with the size of 12 mm×12 mm×7 mm when the diameter of the flange 3 is configured to be 5.4 mm. As illustrated in an enlarged figure of FIG. 6, the abrasive 16 is formed by combining large aluminum oxide particles 18 with a binder 17 that includes small silicon particles 17a and aluminum oxide particles 17b, and clayey soft binding material 17c. The sizes of the small particles 17a and 17b are in the range of 1-10 μm. In addition, the size of the large aluminum oxide particles 18 is in the range of 40-250 μm.

When the first rough barrel finishing process is completed, in a step S3, a chemical polishing process is performed with acid fluid, for instance. In the chemical polishing process, the surface is softened by removing minute foreign substances on the surfaces of the bottom surface 3c and the top surface 3d of the flange 3 and the like (i.e., abrasive attaching to the surface of the flange 3).

In a step S4, a second rough barrel finishing process is performed for the both surfaces of the flange 3 after the chemical polishing process is performed. The second rough barreling is performed for about 2 hours with the vibration barrel finishing machine and the abrasive 16 illustrated in FIGS. 5 and 6 just as used in the first rough barreling. Note that in the rough barrel finishing process of the present embodiment, the silicon particles 17a and the aluminum oxide particles 17b are included as the minute particles included in the binder 17. However, composition of the minute particles is not limited to the above described composition as long as the minute particles include at least one of the group of silicon particles, aluminum oxide particles, and silicon carbide particles. Accordingly, the surface is ground and a plurality of small particles 17a and 17b are diffused and disposed on the surface. Therefore, the second rough barrel process is included in a disposition process for diffusing and disposing the minute particles 15.

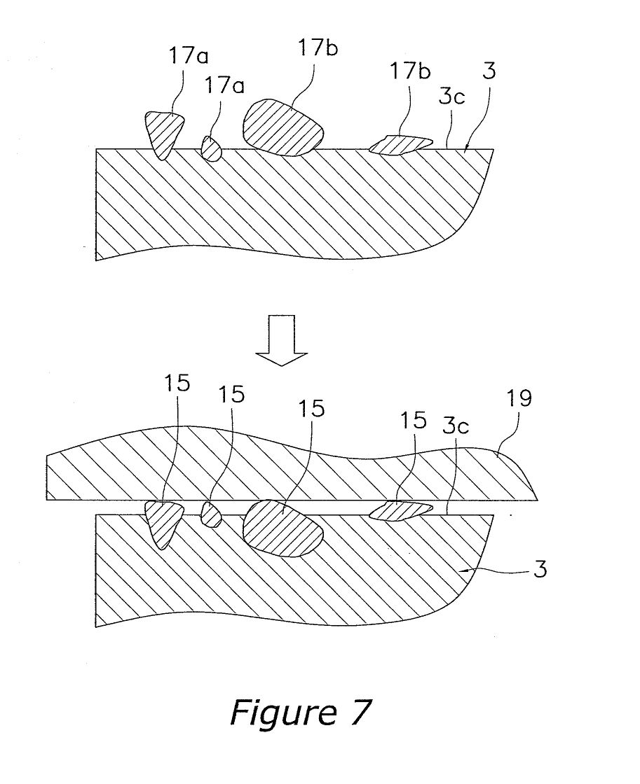

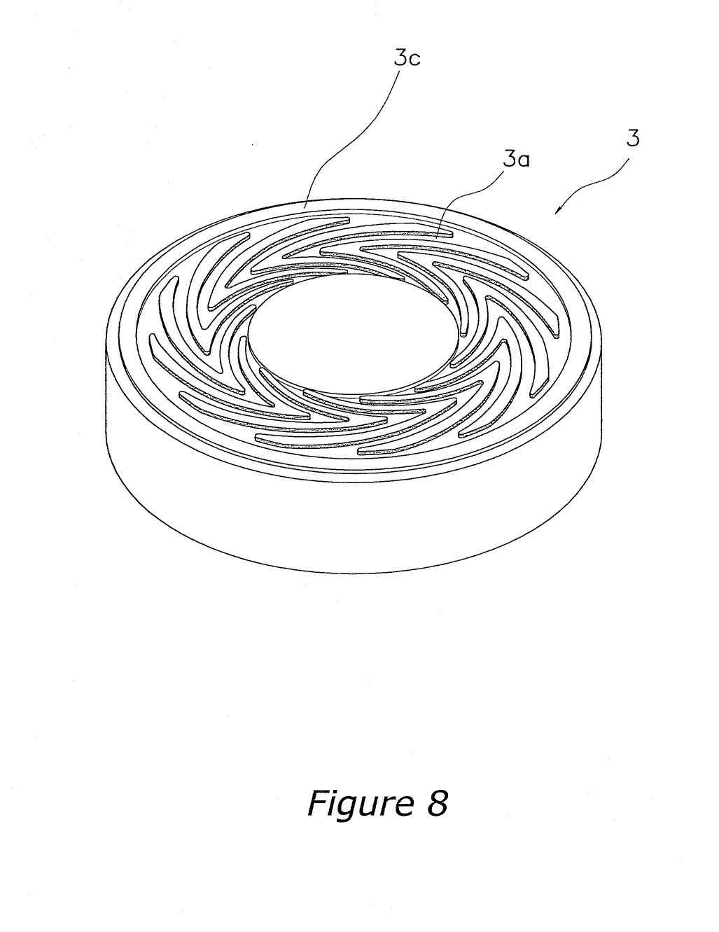

In the second rough barrel finishing process, foreign materials attaching on the surface are cleaned with carbon hydride and the like after the process is completed. However, the surface of the flange 3 is changed to be in a soft state by the chemical polishing. Because of this, in the rough barrel finishing process, the following situation is assumed to be occurred. That is, the shape of the hard large aluminum oxide particles 18 is not changed, but the soft binding material 17c are broken up. As illustrated in FIG. 7, the small particles such as the silicon particles 17a and the aluminum oxide particles 17b, which are included in the interior of the binder 17, are attached to the surface of the flange 3 while the surface of the flange 3 is dented. Almost the attaching residual small particles 17a and 17b are not removed even if a cleaning is performed.

In a step S5, a coining (or repressing) process is performed for producing a thrust dynamic pressure generation groove 3a. For example, the coining process is a process for forming the thrust dynamic pressure generation grooves 3a and 3b with a die 19 by a 10-ton press machine. As illustrated in FIG. 7, in the coining process, the residual small particles 17a and 17b on the bottom surface 3c on which the thrust dynamic pressure groove is formed are pressured with the die 19 and implanted into the bottom surface 3c such that a portion of the particles 17a and 17b protrude from the bottom surface 3c. Thus, manufacturing of the flange 3 is completed.

Here, the implanted small particles 17a and 17b will move particulates 15 position, and the protruded mount of the particulates 15 will be approximately constant. Therefore, the coining process is included in an implantation process for implanting the particulates 15.

In addition, the area of the diffused and disposed particulates 15 is preferably in the range of 3-10% of the area that the bottom surface 3c and the front surface 4a are opposed to each other. When the area of the particulates 15 is less than 3% of the opposed area, the surface pressure to be applied to one of the particulates 15 will be increased. Accordingly, the other surface may be scratched. On the other hand, when the area of the particulates 15 is more than 10% of the opposed area, the duration when the particulates 15 are attached to the bottom surface 3c will be longer. Accordingly, manufacturing cost will be increased.

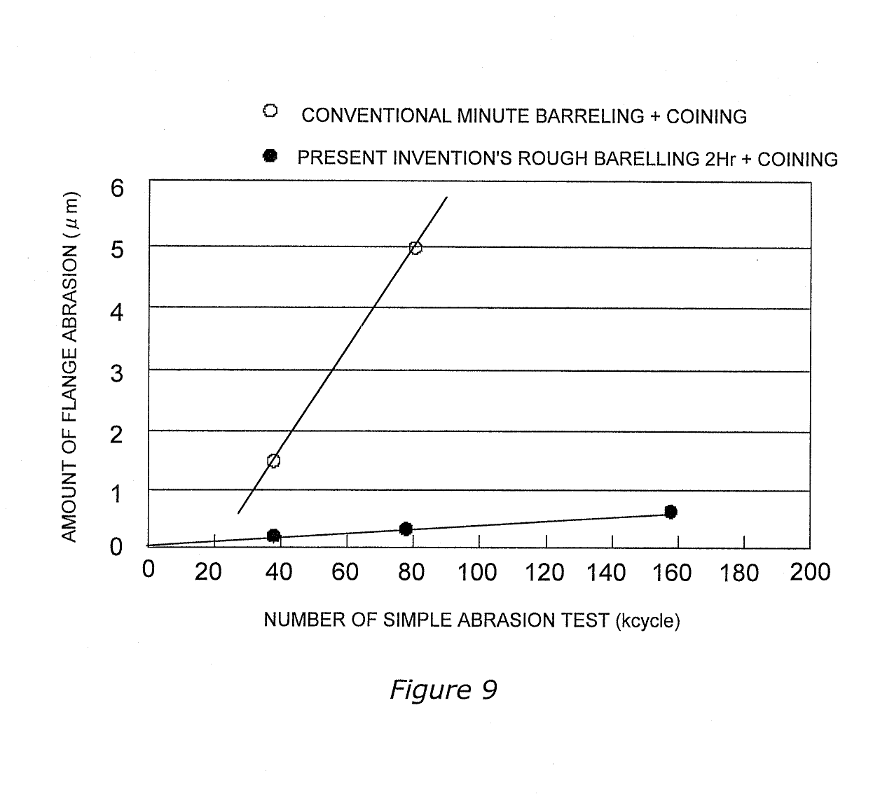

FIG. 9 illustrates a chart for comparing variation in amount of abrasion depending on the number of tests between cases that the flange manufactured in the present embodiment and a flange of a comparative example are respectively incorporated in a spindle motor. Note that the comparative flange is manufactured by performing a minute barrel process with aluminum oxide particles with the size of 0.5 mm instead of performing the second rough barrel finishing process (disposition process) after the chemical polishing, and then by performing the coining process. The both flanges have the same size of 5.4 mm. Note that the number of abrasion tests is indicated by kilo-cycle (kcycle). In the test, a single start-up and shutdown operation is defined as a cycle, and a cycle test is performed in a minute.

As illustrated in FIG. 9, according to the conventional flange, the amount of abrasion in 80,000 cycles is 5 μm. On the other hand, according to the flange of the present embodiment, the amount of abrasion in 80,000 cycles is reduced to approximately 0.3 μm. This also shows that the amount of abrasion of the flange 3 is markedly reduced with the present invention.

### Thrust Plate 4

For example, as illustrated in FIG. 3, the thrust plate 4 is a disk-shaped member made of high-hardness martensitic stainless steel for which a hardening process by quenching with material such as SUS420J2 (JIS) is easily performed. Specifically, a hardening process by quenching is performed for the front surface 4a of the thrust plate 4, and the Vickers hardness of the front surface 4a is approximately 400-500 that is lower than that of the particulates 15. As described above, as illustrated in FIG. 2, the thrust plate 4 is attached to the inner peripheral side of the annular recess 2c that is formed in the sleeve 2 on the lower side of the axial direction. The thrust bearing portion 22 is formed between the thrust plate 4 and the lower surface of the flange 3 in the axial direction, which is attached to the shaft 1 on the lower side of the axial direction. A sealing cap 5 is an annular member to be fixed to the end portion of the sleeve 2 on the upper side of the axial direction, and includes a fixed portion 5a and a ventilating hole 5b.

The fixed portion 5a is a cylindrical member to be fixed to the sleeve 2, and is attached to the sleeve 2 such that it is engaged with an annular step portion formed on the outer peripheral end portion of the sleeve 2 on the upper side of the axial direction.

The oil 6 is held in gaps among the sleeve 2 including the radial bearing portion 21 and the thrust bearing portion 22, the shaft 1, the flange 3, and the thrust plate 4, the circulation hole H formed in the sleeve 2, and the like.

In addition, the oil 6 circulates in the bearing by means of the circulation force toward the lower side of the axial direction because the radial dynamic pressure generation groove 2b formed in the radial bearing portion 21 is asymmetrically formed in the axial direction.

Note that the low-viscosity fluid such as ester oil, fluorinated oil, or the like may be used as the lubricating fluid. In addition, not only ionic liquid but also air or the like may be used as the lubricating fluid as long as the fluid is the low-viscosity and low-evaporativity liquid.

### Operation of Spindle Motor 30

An operation of the spindle motor 30 will be hereinafter explained.

In the spindle motor 30, as illustrated in FIG. 1, the rotation magnetic field is generated when electricity is provided to the stator 10, and the rotational force is applied to the rotor magnet 9. Because of this, it is possible to rotate the rotation member 31 with the shaft 1 while the shaft 1 serves as a rotation center.

As illustrated in FIG. 3, when the shaft 1 rotates, the bottom surface 3c of the flange 3 and the front surface 4a of the thrust plate 4 may make contact with each other in the low-speed rotation. However, in the present embodiment, the hard particulates 15 are diffused and disposed on the bottom surface 3c of the flange 3 such that a portion of the particulates 15 protrudes from the bottom surface 3c. Therefore, an uneven surface is formed on the bottom surface 3c by the particulates 15, and thus a gap is generated between the flange 3 and the thrust plate 4. As a result, an absorption phenomenon is not easily generated between the bottom surface 3c and the front surface 4a. In addition, the oil enters into the gap, and thus it prevents abrasion from easily advancing. Furthermore, the uneven surface is formed, and thus the area that the bottom surface 3c and the front surface 4a make contact with each other will be reduced, and the load torque by the frictional resistance will be reduced. As a result, the rotation speed will be rapidly increased to the floating rotational speed. Accordingly, it prevents abrasion of the front surface 4a from easily advancing. In addition, the hardness of the particulates 15 is higher than that of the front surface 4a, and the hard particulates 15 make contact with the front surface 4a. Therefore, abrasion and seizure are prevented from being easily generated between the bottom surface 3c and the front surface 4a. Furthermore, the particulates 15 are diffused and disposed, and thus it is possible to prevent the surface pressure from being increased. Based on the above described factors, it is possible to prevent abrasion and scratch of the both surfaces 3c and 4a from being generated.

When the rotation speed is increased, the supporting pressure in the radial direction and in the axial direction is generated in each of the dynamic pressure generation grooves 1b, 3a, and 3b. Thus, the shaft 1 is supported in a non-contact state with respect to the sleeve 2. In other words, it becomes possible for the rotation member 31 to rotate with respect to the stationary member 32 in a non-contact state. Accordingly, the high-precision high-speed rotation of the recording disk 11 will be achieved.

### Features of Fluid Bearing Mechanism 40

(1) As illustrated in figures such as FIG. 3, in the fluid dynamic bearing mechanism 40 in accordance with the present embodiment, the particulates 15 are diffused and disposed on the bottom surface 3c of the flange 3 such that a portion of the particulates 15 protrudes from the bottom surface 3c, and are implanted into the bottom surface 3c by applying a pressure.

Thus, the uneven surface is generated by the particulates, and a gap is generated between the flange 3 and the thrust plate 4. As a result, an absorption phenomenon is not easily generated between the bottom surface 3c of the flange 3 and the front surface 4a of the thrust plate 4 in a low-speed rotation. In addition, the oil 6 enters into the gap, and thus it prevents abrasion from easily advancing. Furthermore, the uneven surface is formed, and thus the area that the bottom surface 3c and the front surface 4a make contact with each other will be reduced, and the load torque by the frictional resistance will be reduced. As a result, the rotation speed will be rapidly increased to the floating rotational speed. Thus, it prevents abrasion of the front surface 4a from easily advancing. In addition, the hardness of the particulates 15 is higher than that of the front surface 4a, and the hard particulates 15 make contact with the front surface 4a. Therefore, abrasion and seizure are prevented from being easily generated between the bottom surface 3c and the front surface 4a. Furthermore, the particulates 15 are diffused and disposed, and thus it is possible to prevent the surface pressure from being increased. Based on the above described factors, it is possible to prevent abrasion and scratch of the both surfaces 3c and 4a from being generated.

As a result, the motor life of a device for reading from and writing to a disk, such as a HDD motor into which the fluid dynamic bearing mechanism 40 is incorporated, will be prolonged even when the device is formed in a small and thin type.

(2) In the fluid dynamic bearing mechanism 40 of the present embodiment, the particulates 15 are implanted into the bottom surface 3c of the flange 3 on which the thrust dynamic pressure groove 3a is formed, and the hardness of the bottom surface 3c is configured to be lower than that of the front surface 4a of the thrust plate 4. In other words, when the thrust dynamic pressure generation grove 3a is formed on the bottom surface 3c, the thrust dynamic pressure generation groove 3a is normally formed by means of press working called coining (or repressing). Therefore, when the hardness is high, it is difficult to form a high-precision thrust dynamic pressure generation groove 3a. Therefore, the hardness of the bottom surface 3c on which the thrust dynamic pressure generation groove 3a is formed is configured to be lower than that of the front surface 4a of the thrust plate 4 that is opposed to the bottom surface 3c. When the particulates 15 are implanted into the low-hardness surface by applying pressure, implantation is here more easily performed in a shorter time compared to implantation of the particulates 15 into a high-hardness surface. In addition, it is also possible to simultaneously implant the particulates 15 in the press process in which the thrust dynamic pressure generation groove 3a is formed. In this case, it is possible to simplify the manufacturing process, and it is also possible to prevent the manufacturing cost from increasing. Note that the Vickers hardness of the bottom surface 3c into which the particulates 15 are implanted is preferably 350 or less.

In addition, the bottom surface 3c on which the thrust dynamic pressure generation groove 3a is formed and the front surface 4a on which no thrust dynamic pressure generation groove 3a is formed may make contact with each other in the start-up and the shutdown. However, when the particulates 15 are implanted into the bottom surface 3c on which the thrust dynamic pressure generation groove 3a is formed, a gap is generated between the two surfaces 3c and 4a, and the bottom surface 3c on which the thrust dynamic pressure generation groove 3a is formed is prevented from being easily scraped by the hard front surface 4a. Because of this, deformation, such as deformation in the depth of the thrust dynamic pressure generation groove 3a, is not easily generated by abrasion, and thus it is possible to generate stable dynamic pressure in the thrust dynamic pressure generation groove 3a.

(3) In the fluid dynamic bearing mechanism 40 in accordance with the present embodiment, the particulates 15 include at least one of the group of aluminum oxide and silicon. Here, the particulates 15 are composition of abrasive to be used in a normal barrel finishing process and the like. Therefore, it is possible to use the abrasive 16 to be used in the barrel finishing as the particulates 15. Accordingly, there is no need to prepare particulates to be used exclusively for implantation. Thus, the manufacturing process is further simplified and it is possible to further prevent the manufacturing cost from increasing.

### OTHER EMBODIMENTS

As described above, an embodiment of the present invention has been explained. However, the present invention is not limited to the above described embodiment, and a variety of changes are possible without departing from the scope of the present invention.

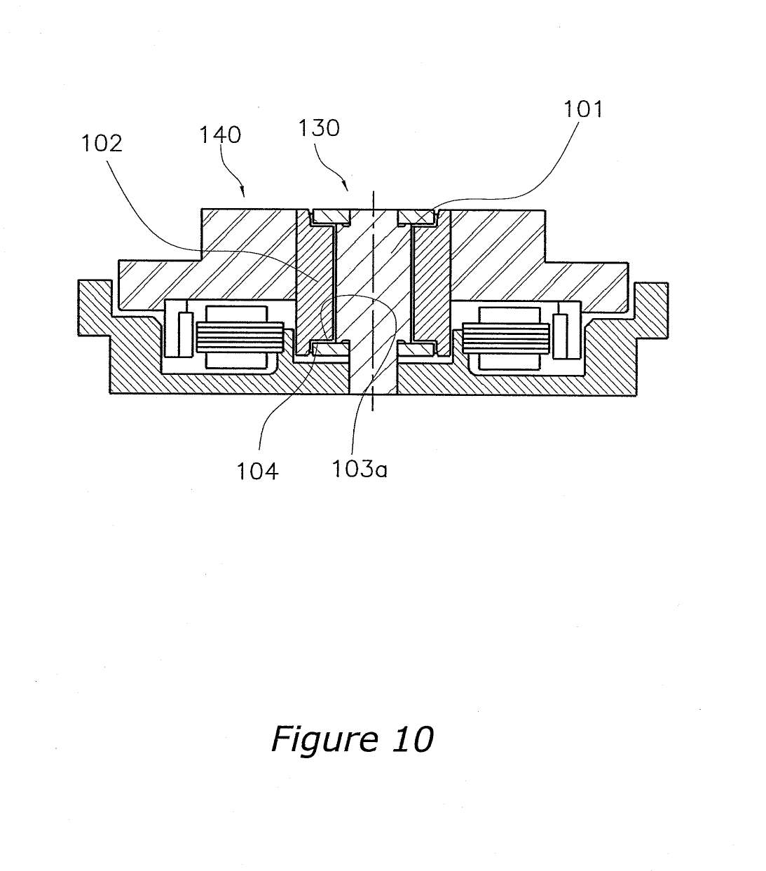

(A) In the above described embodiment, a bearing part configured to be used for a shaft-rotation type spindle motor in which the shaft 1 rotates is disclosed. However, as illustrated in FIG. 10, it is also possible to apply the present invention to a flange 103a (an example of a baring part) configured to be used for a fluid dynamic bearing mechanism 140 of a shaft-fixed type spindle motor 130 in which a shaft 101 is fixed.

Even in the case, a gap is generated between the flange 103a and a thrust receiver 104 formed in the sleeve 102. Therefore, it is possible to achieve the same working effect as that achieved by the above described embodiment.

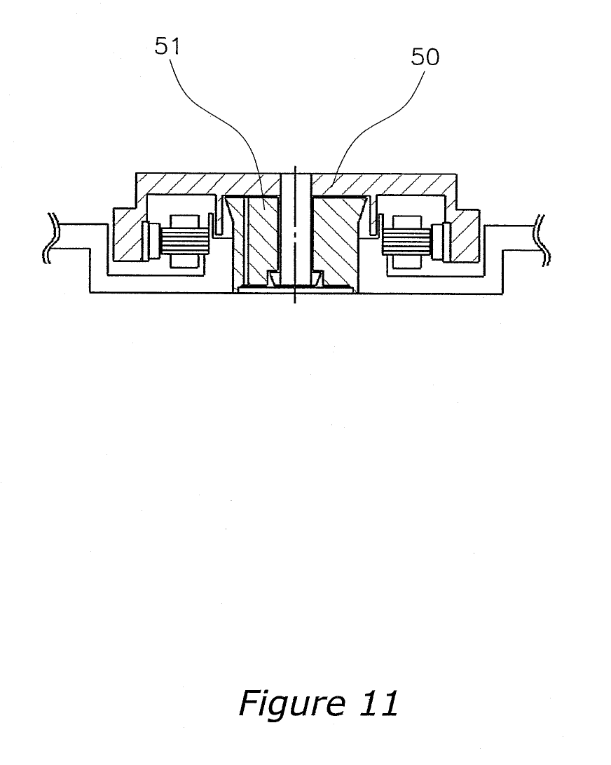

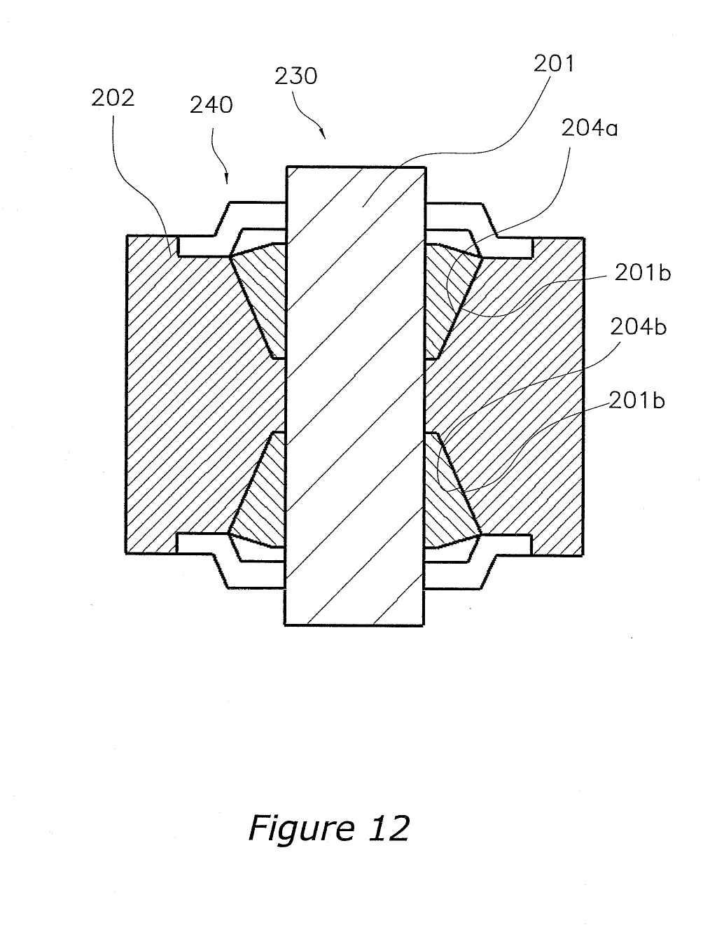

(B) In the above described embodiment, the particulates are implanted into the flange 3 that serves as a bearing part. However, the particulates may be implanted into a thrust plate that serves as a bearing part. In addition, in such a case that the spindle motor is inverted and used, the particulates may be screwed into and disposed on the bottom surface of the sleeve or the top surface of the flange, which serve as bearing parts. As illustrated such as in FIG. 11, in addition, in a case that a bearing portion is formed by the opposed surfaces of the hub50 and the sleeve51, the particulates may be implanted into either the bottom surface of the hub50 or the top surface of the sleeve51. In other words, the particulates may be disposed on either of the opposed surfaces that make contact with each other in the low-speed rotation.

(C) In the above described embodiment, the abrasive configured to serve as particulates in a barrel finishing process is disposed. However, the present invention is not limited to this. For example, hard material may be diffused and disposed as particulates on the surface of a bearing part by vibration or the like, and may be implanted into the surface by a press machine. Especially, when the particulates are implanted into a portion on which no thrust dynamic pressure generation groove is formed, this type of implantation process is necessary.

(D) In the above described embodiment, the group of aluminum oxide and silicon are used as the particulates that are configured to be implanted. However, the present invention is not limited to this. For example, at least one of the group of silicon carbide, chrome oxide, diamond, silicon nitride, cerium oxide, and titanium carbide may be used. When these high-hardness particles are used, it is possible to achieve the same working effects as that of the above described embodiment.

(E) In the above described embodiment, the flange is formed as a plate-shaped member. However, the present invention is not limited to this. For example, the flange may be formed in an annular shape with a L-shaped cross-section.

(F) In the above described embodiment, the flange is provided for the shaft, and the first surface is formed on the flange. However, the present invention is not limited to this. For example, the end surface of the shaft is configured to be the first surface while the diameter of the shaft is formed in a large size without forming the flange. In this case, it is possible to achieve the same working effect as that of the above described embodiment when a thrust plate, which serves as a thrust receiver, is disposed to be opposed to the end surface of the shaft, and the particulates are diffused and disposed on the thrust plate. Not to mention, the particulates may be configured to be implanted on the shaft side.

(G) In the above described embodiment, a configuration including the radial bearing and the thrust bearing is described. However, the present invention is not limited to this. For example, as illustrated in FIG. 12, a conical fluid dynamic bearing mechanism 240 may be configured, which first surfaces 201a and 201b of a shaft 201 and second surfaces 204a and 204b of a sleeve 202 slant with respect to the central axis of a shaft 201 and are opposed to each other. With this configuration, it becomes possible to achieve higher bearing stiffness.

(H) In the above described embodiment, an example is explained that the present invention is applied to the fluid dynamic bearing mechanism 40 and the spindle motor 30 including the same. However, the present invention is not limited to this.

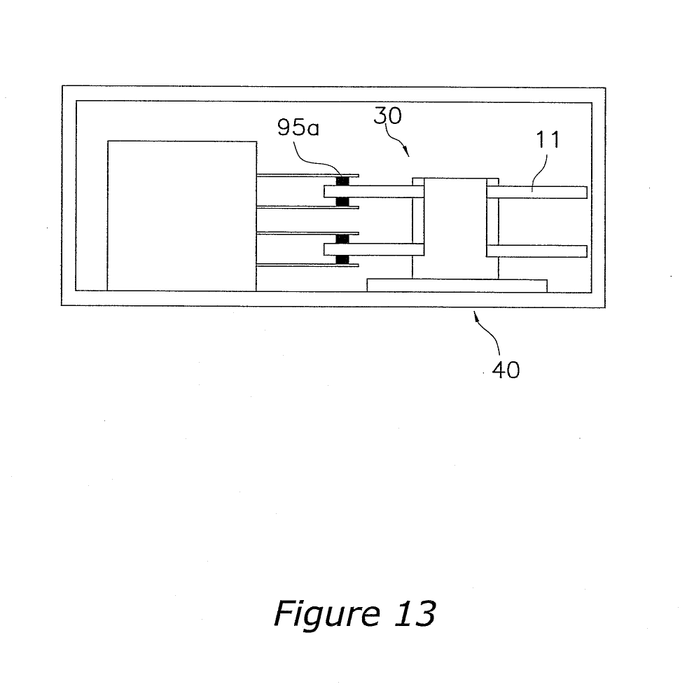

For example, as illustrated in FIG. 13, it is possible to apply the present invention to the read-write device 95 that incorporates the fluid dynamic bearing mechanism 40 with the above described configuration and the spindle motor 30, and is configured to retrieve information recorded in the recording disk 11 and to record information in the recording disk 11 by a recording head 95a.

With this configuration, it is possible to achieve a read-write device for meeting the demand of the small and thin typed device without deteriorating performance and quality.

### INDUSTRIAL APPLICABILITY

According to the fluid dynamic bearing device of the present invention, the following working effects are achieved. That is, it is possible to form a thin typed fluid dynamic bearing device without deteriorating reliability, and it is possible to prevent abrasion and scratch even when two parts make contact with each other. Accordingly, it is possible to apply the present invention to a variety of devices such as a fluid dynamic bearing device that is configured to be incorporated into a highly reliable spindle motor, which is preferably used for an in-car application or a portable application, with the recording media such as the optic recording media, the magneto-optic recording media, and the magnetic recording media.

What is claimed is:

1. A fluid dynamic bearing device, comprising:
a shaft member;
a sleeve member including a bearing hole, the bearing hole supporting the shaft member through a minute gap such that the shaft member is allowed to relatively rotate with the bearing hole;
a first surface integrally being formed with the shaft member, the first surface being opposed to the inner surface of the bearing hole;
a second surface being disposed on the sleeve member through the minute gap with respect to the first surface;
a dynamic pressure bearing portion including a plurality of dynamic pressure generation grooves and a lubricating fluid being held in the minute gap, the plurality of dynamic pressure generation grooves being formed on at least one of the first surface and the second surface, and
a plurality of particulates being diffused and disposed on a portion of or the entire of at least one of the first surface and the second surface, the particulates being implanted thereinto by applying pressure such that a portion of the particulates protrudes therefrom, the particulates having hardness higher than that of the other surface being opposed to the surface that the particulates are implanted therein.

2. The fluid dynamic bearing device according to claim 1,
wherein the particulates are implanted into a surface on which the dynamic pressure generation grooves are formed; and
wherein the surface on which the dynamic pressure generation grooves are formed has hardness lower than that of the other surface.

3. The fluid dynamic bearing device according to claim 1, wherein the dynamic pressure bearing portion has a thrust bearing portion including portions being configured to be opposed to each other in an axial direction of the shaft member and a radial bearing portion including portions being configured to be opposed to each other in a radial direction of the shaft member, and the first surface and the second surface form the thrust bearing portion and the radial bearing portion.

4. The fluid dynamic bearing device according to claim 3, wherein the shaft member includes a flange shaped portion, the flange shaped portion being formed in the vicinity of the end portion of the shaft member.

5. The fluid dynamic bearing device according to claim 3, wherein the first surface is formed on the end surface of the shaft member.

6. The fluid dynamic bearing device according to claim 3, wherein the sleeve member includes a sleeve and a thrust plate, the sleeve serving as a main body, the thrust plate being relatively fixed to the sleeve.

7. The fluid dynamic bearing device according to claim 1, wherein the dynamic pressure bearing portion includes a conical bearing portion, the conical bearing portion having portions being configured to be opposed to each other and slant toward the central axis of the shaft member, the conical bearing portion being formed on the first surface and the second surface.

8. The fluid dynamic bearing device according to claim 1, wherein the particulates include at least one of the group of oxide aluminum, silicon, silicon carbide, chrome oxide, diamond, silicon nitride, cerium oxide, and titanium carbide.

9. A spindle motor, comprising:
a hub that a recording disk is allowed to be mounted thereon;
a magnet being fixed to the hub;
a stator forming a magnetic circuit together with the magnet; and
a fluid dynamic bearing device according to claim 1 by which the hub is supported.

10. A read-write device, comprising:
a recording head for reading and/or writing information from and/or in the recording disk; and
a spindle motor according to claim 9 being configured to be capable of rotating the recording disk.

11. A method of manufacturing a bearing part for a fluid dynamic bearing device, comprising:
a disposing step for diffusing and disposing hard particulates on a surface of a member, the member serving as the bearing part, the particulates having hardness higher than that of the surface; and
an implantation step for implanting the disposed particulates into the surface by applying pressure such that a portion of the particulates protrude from the surface.

12. The method of manufacturing a baring part according to claim 11,
wherein the disposing step includes a barrel finishing process for grinding the surface; and
wherein the particulates are abrasive used and broken up in the barrel finishing process.

13. The method of manufacturing a bearing part according to claim 12,
wherein the abrasive is formed by combining particles with a binder, the particles including at least one of the large particle group of aluminum oxide particle, silicon particle, silicon carbide particle, chrome oxide particle, diamond particle, silicon nitride particle, cerium oxide particle, and titanium carbide particle, the abrasive including at least one of the small particle group of aluminum oxide particle, silicon particle, silicon carbide particle, chrome oxide particle, diamond particle, silicon nitride particle, cerium oxide particle, and titanium carbide particle; and
wherein the particulates are attachment produced after the binder is broken up.

14. The method of manufacturing a bearing part according to claim 11,
wherein the implantation step includes a groove formation step for forming a dynamic pressure generation groove on the surface by applying pressure; and
wherein the particulates are simultaneously implanted into the surface in forming the dynamic pressure generation groove.
